(19) United States
(12) Patent Application Publication
(10) Pub. No.: US 2014/0068458 A1
(43) Pub. Date: Mar. 6, 2014

(54) METHOD AND DEVICE FOR MANAGEMENT OF A MESSAGE AND ATTACHMENT

(71) Applicant: Pantech Co., Ltd., Seoul (KR)

(72) Inventor: Bo Sun KIM, Seoul (KR)

(73) Assignee: Pantech Co., Ltd., Seoul (KR)

(21) Appl. No.: 14/017,570

(22) Filed: Sep. 4, 2013

(30) Foreign Application Priority Data
Sep. 5, 2012 (KR) 10-2012-0098104

(51) Int. Cl. H04L 12/58

(52) U.S. Cl. CPC H04L 51/08
USPC 715/752

(57) ABSTRACT

The present disclosure relates to a message context management method and a terminal performing the method. The message context management method based on an attached file includes: downloading, by a terminal from a host device, messages and attachments to one or more of the messages; generating a message context related to each of the messages and the respective attachments; and displaying the message context related to a file selected from the attachments.

### CROSS-REFERENCE TO RELATED APPLICATION

This application claims priority from and the benefit under 35 U.S.C. §119 of Korean Patent Application No. 10-2012-0098104, filed on Sep. 5, 2012, the contents of which are herein incorporated by reference in its entirety as if fully set forth herein.

### BACKGROUND

1. Field

The present disclosure relates to a message context management method, and more particularly, to a method of storing and using a message context on the basis of an attachment attached to a message, and a terminal performing the method.

2. Description of the Background

When a user downloads contents attached to a message using a terminal, actual contents on a corresponding path are directly downloaded from a server, such as a mail server, to a storage medium. That is, a message application includes a module for downloading the attachments to a storage medium where the attachments are accessed using a server address, for example, using a Uniform Resource Locator (URL).

FIG. 1 illustrates context information for an attachment to a message. In the related art, when a user downloads and stores the message attachment in a terminal, the attachment is classified into separate contents unrelated to the message or the mail server after the attachment has been stored. Accordingly, when the user accesses the stored contents through a file manager or the like, it is difficult to provide the context or content related to a download history of the attachment to the user.

In the related art, there are many cases where it is necessary to provide notification to some content in the message and information about a required action. In the related art, there is no additional information or context related to the message when the attachment contents are stored. When the user stores many attachments related to many messages, it is difficult to know the reason why the related contents are stored and what specific messages are related to the contents.

### SUMMARY

Exemplary embodiments of the present invention provide an apparatus and method for accessing a context for a message attachment.

The present disclosure is directed to generating and storing context information related to a message when an attachment to the message is stored.

In the message context management method, or in a terminal performing the method according to various aspects of the present disclosure, the message context related to the attachment and the message is generated and used. As such, it is possible to efficiently manage the message and its attachments.

According to exemplary embodiments, there is provided a message context management method including: receiving, by a messaging application, a message with an attachment; downloading the attachment; generating a message context associated with the attachment, wherein the message context includes information about the message and the attachment; and storing the message context.

According to exemplary embodiments, there is provided a mobile apparatus including message context management including: a communications interface configured to receive with a messaging application a message with an attachment and configured to download the attachment; a message context manager configured to generate a message context associated with the attachment, wherein the message context includes information about the message and the attachment; an attached file manager to manage the downloaded attachment; and a database configured to store the message context.

According to exemplary embodiments, there is provided a message context management method including: downloading, by a terminal from a host device, messages and attachments to one or more of the messages; generating a message context related to each of the messages and the respective attachments; and displaying the message context related to a file selected from the attachments.

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 illustrates context information about a file attached to a message per the related art.

FIG. 2 illustrates a system including a terminal and a host device according to exemplary embodiments of the present disclosure.

FIG. 3 illustrates a display of a file received as an attachment and an associated message context according to exemplary embodiments of the present disclosure

FIG. 4 illustrates various icons by which an attached file is displayed on a terminal according to exemplary embodiments of the present disclosure.

FIG. 5 illustrates a popup window in which properties of a message context may be set according to exemplary embodiments of the present disclosure.

FIG. 6 illustrates a method of confirming a download state of an attached file and performing a re-download according to exemplary embodiments of the present disclosure.

FIG. 7 illustrates an exemplary reply window of a message according to exemplary embodiments of the present disclosure.

FIG. 8 illustrates a database (DB) connected to a terminal according to exemplary embodiments of the present disclosure.

FIG. 9A and FIG. 9B illustrate a method of restricting access to a message context using a password according to exemplary embodiments of the present disclosure.

FIG. 10 illustrates a message context management method based on an attached file according to exemplary embodiments of the present disclosure.

FIG. 11A and FIG. 11B illustrate a message context in a terminal according to exemplary embodiments of the present disclosure.

FIG. 12A and 12B illustrate are-download of an attached file when the download of the attached file was not completed according to exemplary embodiments of the present disclosure.

FIG. 13 illustrates a popup window for user authentication according to exemplary embodiments of the present disclosure.

FIG. 14A, FIG. 14 B and FIG. 14C illustrate a content body of a message according to exemplary embodiments of the present disclosure.

FIG. 15A, FIG. 15B and FIG. 15C illustrate dialogue type messages displaying a position of a message according to exemplary embodiments of the present disclosure.

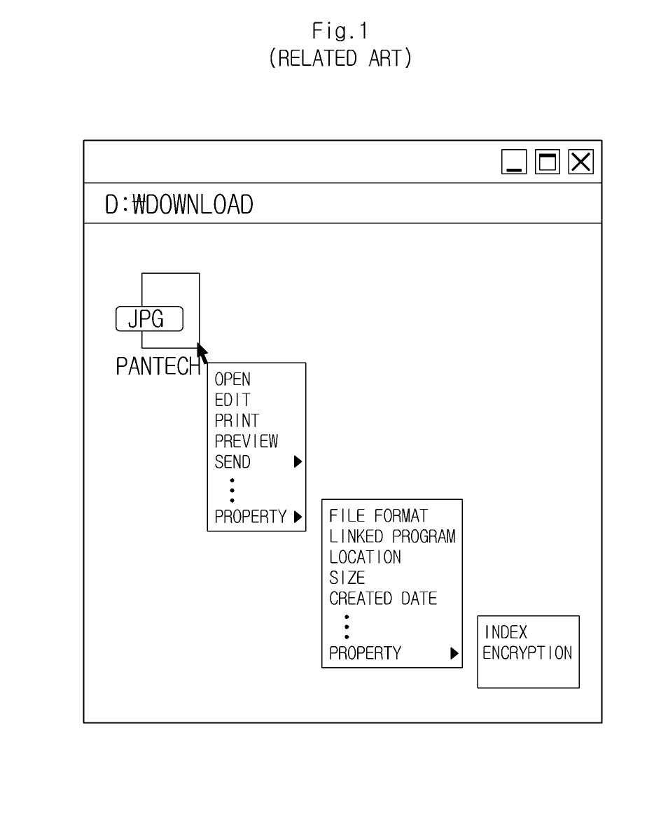

### DETAILED DESCRIPTION

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

A terminal according to exemplary embodiments of the present disclosure may generate a message context on the basis of an attached file downloaded from a host device through a message application, and may provide the generated message context to a user.

The host device may be a messenger, or a mail management or web server, and the terminal may download the attached file attached to a message from the host device. The terminal may generate message status information (context) related to the terminal and the host device on the basis of the attached file. It is possible to provide various functions to the user on the basis of message status information.

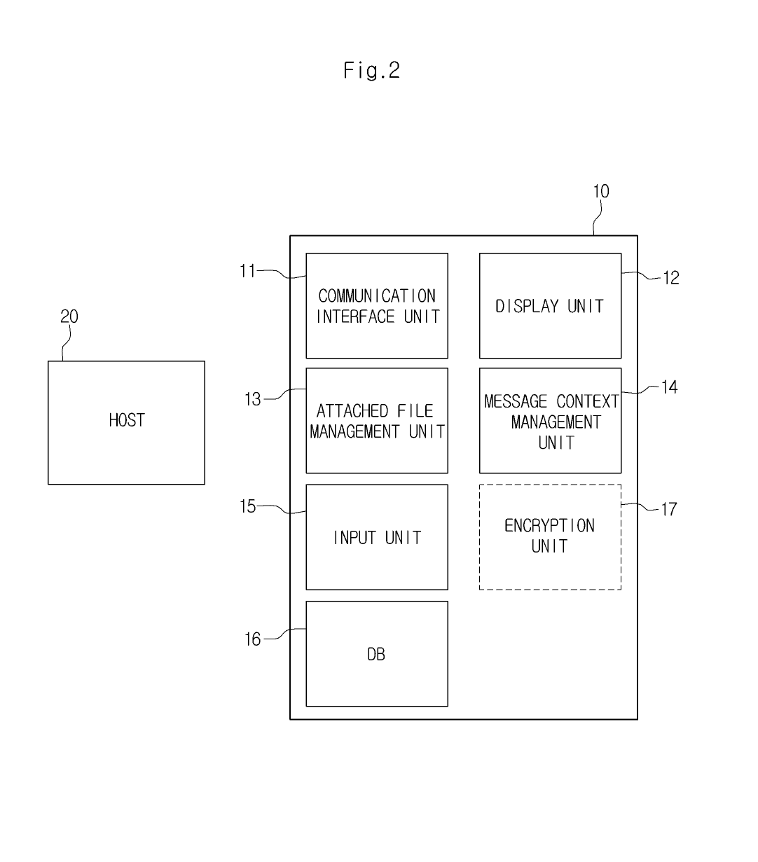

FIG. 2 illustrates a system including a terminal and a host device according to exemplary embodiments of the present disclosure. The system including a terminal 10 and a host device 20 according to exemplary embodiments of the present disclosure is illustrated. Terminal 10 may include a communication interface unit 11, a display unit 12, a message context management unit 14, and an input unit 15. In some embodiments, terminal 10 may include an attached file management unit 13 and/or a DB 16. The terminal 10 may include an encryption is unit 17.

A message may include an e-mail, a messenger dialogue, and the like. For example, the e-mail message may include a message about a messenger dialogue transmitted using an arbitrary e-mail application, for example, NATE-ON, KAKAO TALK, and LINE. However, the message is not limited thereto such that the message may be a text, chat, or other message.

The attached file may include an image, a moving image, a document, a compressed file, a program file, and/or an arbitrary file which may be received as an attachment or attached to the message.

When the received message is related to the e-mail, a message context related to the attached file may include: a sender, a recipient, an e-mail identification number of the e-mail transmitted including the attached file to be downloaded, an e-mail application kind, an e-mail priority, a content body of the e-mail, other files attached with the attachment, an attached file download state, a flag indicating whether or not the e-mail is a dialogue type e-mail, time information about the e-mail, or time information about the download of the attached file.

The e-mail identification number can be an identification number representing an order of receiving each e-mail. In addition, even when an e-mail is received from the same sender of the message, the identification number may be different and permit discriminating dialogue type and non-dialogue type messages.

An e-mail application kind identifies the e-mail program used to send the e-mail. For example, the e-mail application kind may be G-MAIL, NAVER-MAIL, NATE-MAIL, YAHOO-MAIL, or the like.

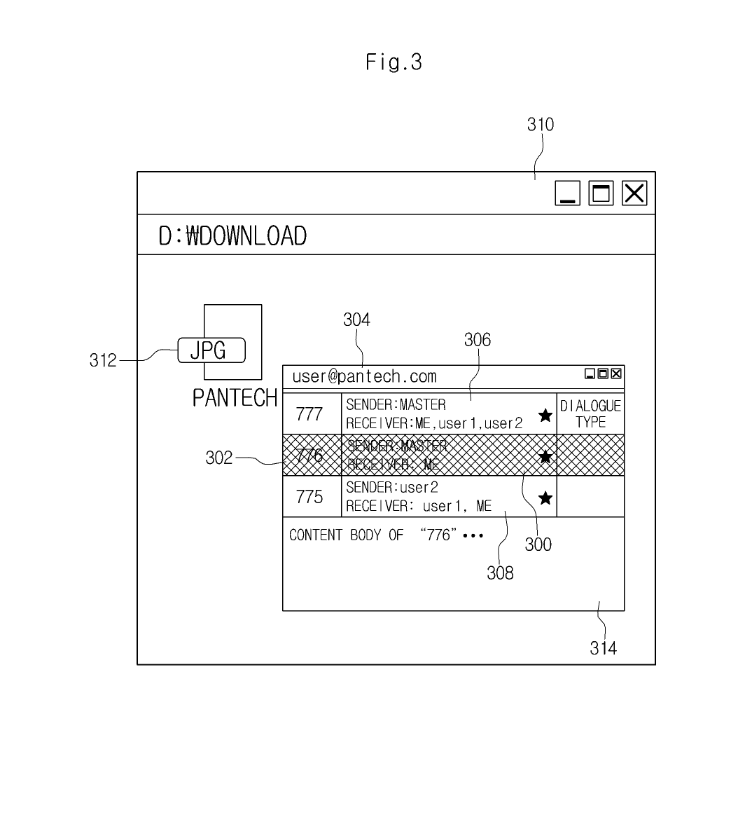

FIG. 3 illustrates a display of a file received as an attachment and an associated message context according to exemplary embodiments of the present disclosure. A display 310 including a file 312 received as an attachment and a list of message contexts, including message context 300 is illustrated. Message context 300 conveys to a user that attachment 312 was downloaded with an e-mail body. The message context 300 is hashed or highlighted to indicate that it is associated with attachment 312 and a content body 314 being displayed is associated with message context 300. In the illustration, the highlighted row for message context 300 displays at least some of the data associated with the message context 300. The message context 300 includes an identification number “766” (302) and that the receiver of the e-mail used the address user@pantech.com 304. In addition, additional message contexts for other e-mails having identification numbers adjacent to the “766” message are displayed. The additional message contexts 306, 308 can aid the user to more accurately recognize the selected e-mail.

In some embodiments, when a message context relates to a messenger dialogue (not shown), the message context may be a dialogue participant, a dialogue window identification number of the messenger dialogue in which the downloaded attached file is transmitted, a type of a messenger application, a dialogue content of a dialogue window, any other files attached with the attachment, an attached file download state, and time information about the download of the attached file.

In the identification number of the dialogue window, a new identification number may be given to each participant. Even when a messenger dialogue with the same participant, when the messenger dialogue window is closed and then the dialogue window is activated, a dialogue window to which a new identification number is given may be generated.

The message context may include metadata about an attached file. The metadata can be provided for an attached file regardless of whether the attached file is associated with a messenger or non-messenger dialogue. The metadata may include a message address about the people related to the message, for example, a sender, a receiver, and a reference, an ID of the message application, a title of the message, and various sending/receiving/confirming timestamps. Message type may be classified according to at least one of a dialogue/non-dialogue type, a reply requirement/non-requirement, an importance level, an order of receipt, a sender, a recipient, and the like.

In exemplary embodiments, the input unit 15 of the terminal 10 may receive a user's input through an ultrasonic wave electronic pen, a touch pad, a touch screen, a mouse, a keyboard, a track ball, a pointing stick, a tablet or the like.

Terminal 10 may include a moving type or a fixed type. Exemplary terminals include a personal computer, a personal portable terminal (PDA), a navigation device, a smart TeleVision (TV), a digital broadcasting terminal, a Portable Multimedia Player (PMP), a Personal Digital Assistant (PDA), a mobile phone, a tablet PC, and a laptop computer, and are not limited to the items described above.

Host device 20 may be an arbitrary device that stores the attached file, and transmits the attached file to terminal 10. For example, host device 20 may be a messenger server, a mail management server, or a web server, and is not limited thereto.

Communication interface unit 11 of terminal 10 may receive the attached file from host device 20. Communication interface unit 11 of terminal 10 may transmit the attached file to the attached file management unit 13. Communication interface unit 11 may communicate with host device 20 via a wire or wirelessly.

Display unit 12 may include a screen. Display unit 12 may include a touch screen capable of receiving a user input via touch. Display unit 12 may display the attached file downloaded from host device 20. Display unit 12 may display a thumbnail image of the attached file through an OS of the terminal, or may display an icon according to the attached file type.

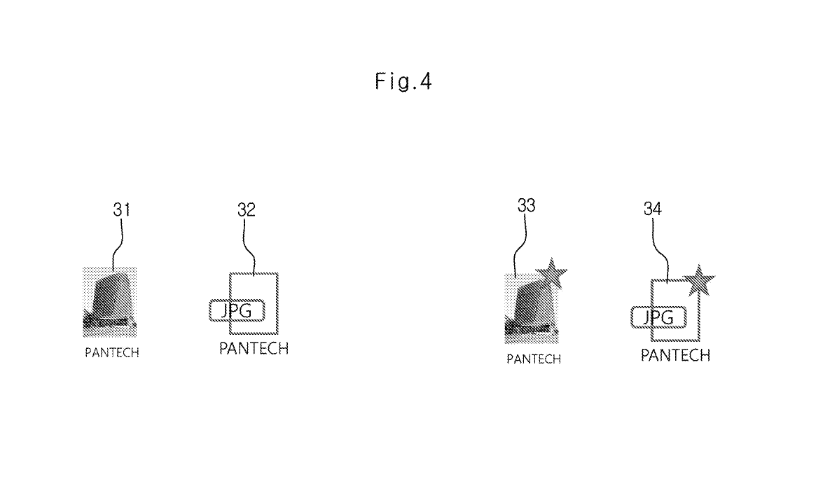

FIG. 4 illustrates various icons by which an attached file is displayed on a terminal according to exemplary embodiments of the present disclosure. For example, an image file having extension of JPG may be displayed as a thumbnail image 31 or as an icon 32.

In some embodiments, when the attached file is downloaded and attached to an importance-displayed message, the display unit may display the download state of the attached file or the importance of the received message. For example, the display may include a thumbnail image 33 or an icon 34 in which the importance of the received message may be represented by a star. The importance display may be different according to the message application or the OS used by the user. For example, the importance display need not be indicated by a star and may be indicated by color, shape, outline, shading, shadow, bolding or italicizing of text, and the like. Further, other forms of context information may be represented on the icon. For example, attachment type, attachment count, sender identification information, etc. may be represented on the icon.

An attached file management unit 13 classifies the attached files downloaded by communication interface unit 11 according to document type or kind, and transmits attached files to the DB 16. When the stored attached file is needed, the attached file is obtained from DB 16. Thereafter, the attached file may be transmitted to display unit 12. In some embodiments, attached file management unit 13 may classify an attached file according to importance, extension, or download state. In some embodiments, attached file management unit 13 may transmit the attached files to DB 16.

A message context management unit 14 generates a context related to an attached file and transmits the context to DB 16. In some embodiments, message context management unit 14 may transmit a predetermined message context from DB 16 to display unit 12.

In some embodiments, message context management unit 14 may represent a specific display in or on the icon or the like for the attached file when the download is not completed but a display of the context or message importance or the like is generated.

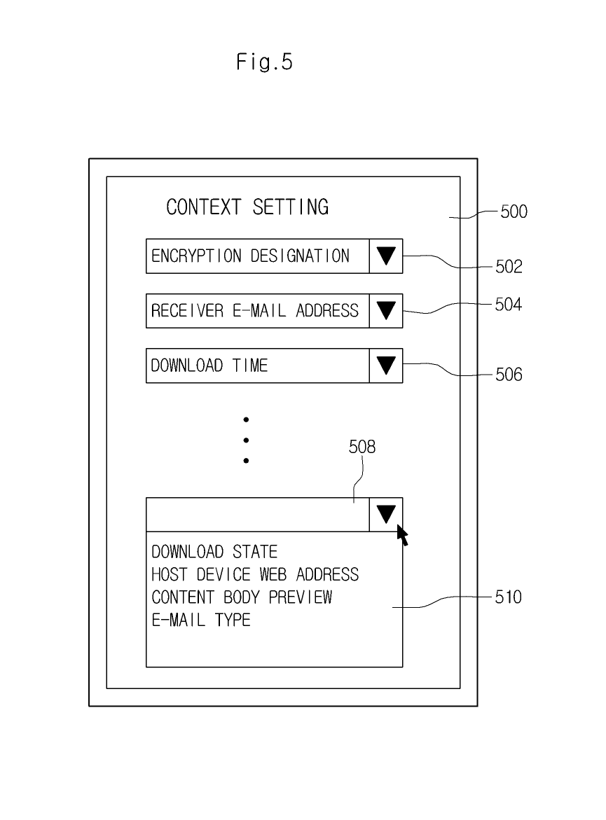

FIG. 5 illustrates a popup window in which properties of a message context may be set according to exemplary embodiments of the present disclosure. As message contexts vary, values for the various properties of a message context may be set prior to display. When setting properties in a message context, for example in a setting mode, the user may set various properties. Some properties can include a predetermined message context list. For example, in context setting window 500, a user can set and/or arrange the context to include and/or display an encryption destination 502, a receiver e-mail address 504, a download time 506, or the like from various drop-down lists. For example, a drop-down box 508 can be set to display various message context properties, such as a download state, a host device web address, a content body preview, an e-mail type, and the like, that may be selected to be displayed.

In some embodiments, when setting properties of the message context (setting mode), the user may set a predetermined message context, for example, password input window display, content body preview, or the like.

Message context management unit 14 may transmit a predetermined message context to display unit 12 to display the message context on the basis of the set information. The setting information values of the message context may be defined, for example, in advance by a service provider or via the context setting window 500 as shown in FIG. 5.

In some embodiments, the terminal may perform specific operations for several contexts of the message context, and the specific operations may be selected by the user or may be set in advance by a service provider. For example, the specific operation may include attached file re-download, displaying the message, execution of a reply window, and the like, and is not limited thereto.

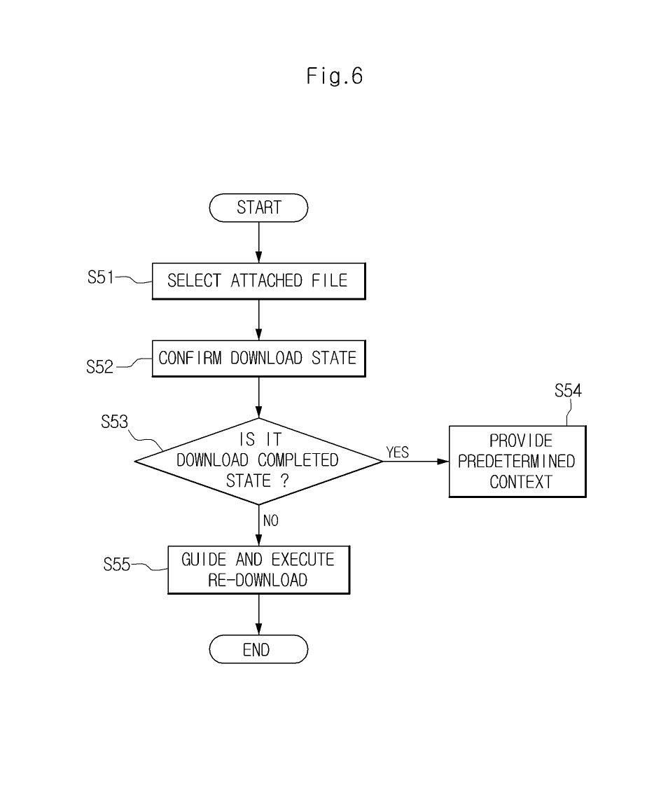

FIG. 6 illustrates a method of confirming a download state of an attached file and performing a re-download according to exemplary embodiments of the present disclosure. As illustrated, the download state of the attached file is confirmed and the re-download is performed. By a situation such as a communication error, only a part of the attached file may be downloaded and it may be difficult to normally perform the attachment download. Accordingly, the message context management unit 14 may confirm whether or not the download of the attachment is completely performed.

Specifically, when the user selects a specific attached file (S51), the message context management unit 14 compares the size of the attachment stored in the DB 16 with the size of the attachment at the time of downloading to confirm the download state (S52). When there is an error in the download state (S53), e.g., when the sizes of the stored attachment and the size of the attachment as indicated at the time of downloading do not match, the user can be guided to re-download the attached file (S55). When the attachment is normally downloaded, a message context can be provided (S54).

In some embodiments, when a download-interrupted attachment is selected, the attached file management unit may provide guidance to the user through a popup window such that the remainder of the interrupted attachment is downloaded or the present attachment is deleted and the download is newly performed.

When the user selects the re-download, the attached file management unit may request the host device 20 to download the attachment on the basis of the original address, for example, a URL, included in the message context of the attachment.

In some embodiments, the attached file management unit may perform a download of the attachment downloaded with the e-mail, the messenger dialogue, and the web. For example, when the attachment is received from an e-mail, the e-mail application by which the e-mail is received and the e-mail identification number may be used for the download. In addition, the attachment downloaded from the messenger may be downloaded using a messenger application and the dialogue window identification number. A file or attachment directly downloaded from the web may be downloaded using a corresponding URL. As such, the terminal 10 may download the other part through the communication interface 11.

In addition, when the ID of the sender or the message account of the attachment displayed by a message context is selected, the terminal may display the reply window for the message.

In some embodiments, the message context management unit 14 may perform a specific function according to the kind of the message. For example, when a message requests a reply and the attached file is selected, the message context management unit 14 may display the reply window for the sender of the message before displaying the other predetermined context.

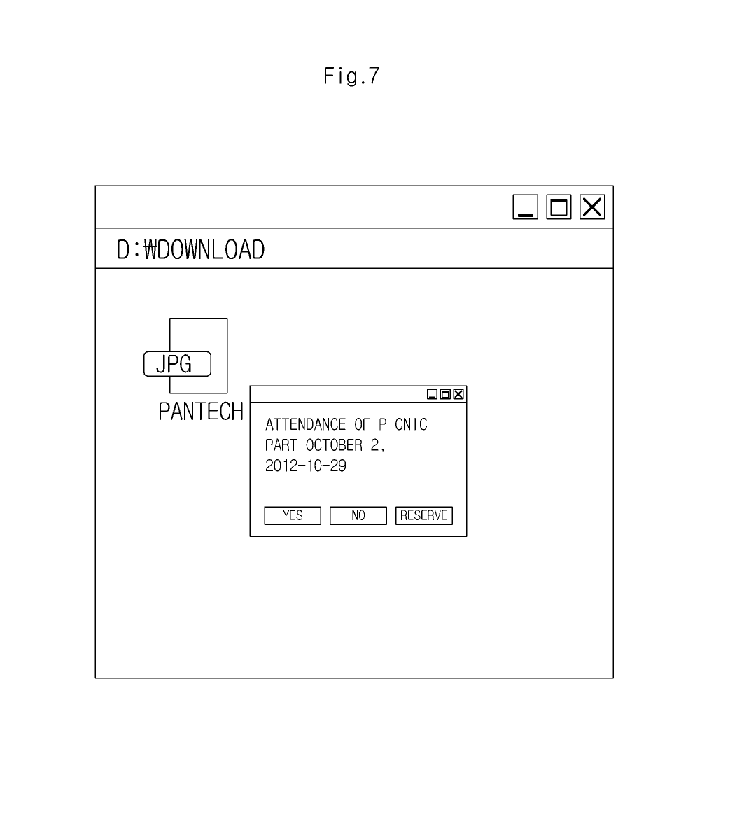

FIG. 7 illustrates an exemplary reply window of a message according to exemplary embodiments of the present disclosure. In response to the downloaded attachment 701 being selected, a reply window 705 may be displayed on top of various windows displayed on the display unit.

As shown in FIG. 7, the message requesting the reply may be a message for attendance of meeting or the like, and may be a message for investigating an opinion of the receiver about a specific plan. Further, if a reply has been previously sent, the reply window 705 may indicate that the reply has been sent or may not be displayed.

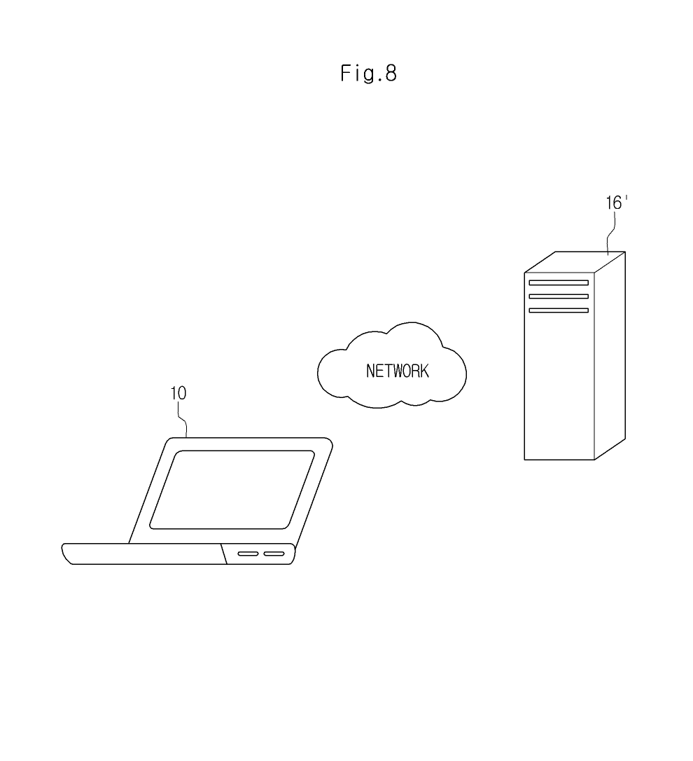

FIG. 8 illustrates a database (DB) connected to a terminal according to exemplary embodiments of the present disclosure. A DB 16′ can be provided out of or external to the terminal. When the DB 16′ is provided out of the terminal 10, the terminal 10 may store the attached file and the message context in the DB 16′ and may call them as necessary on the network using the communication interface 11. DB 16′ may be a physical storage medium external to the terminal 10 or may be included in the terminal 10 as shown in FIG. 2.

In some embodiments, the terminal 10 may further include the encryption unit 17 (see FIG. 2). When accessing the attached file, the message context is exposed, and thus it may be necessary to restrict access to the message context, for example, for protecting personal information under a predetermined condition. Encryption unit 17 may be used when the message is included in the message context.

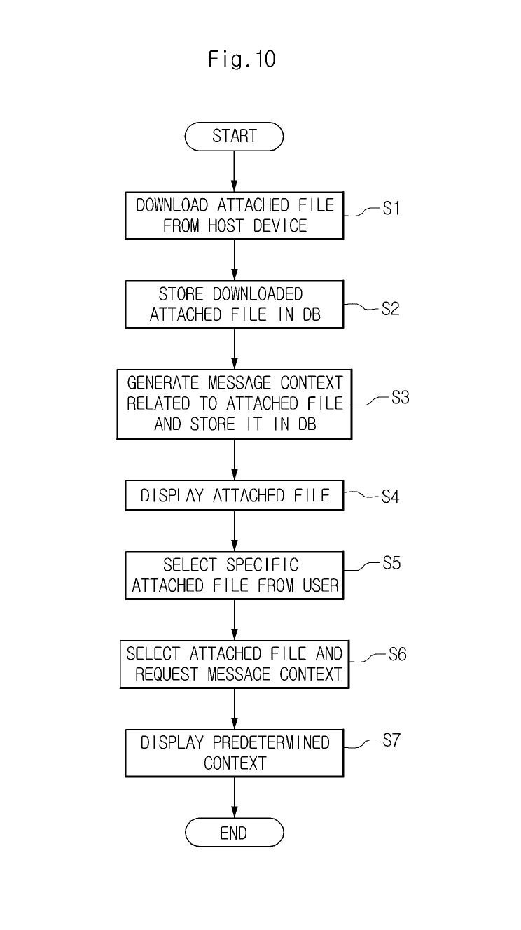

FIG. 10 illustrates a message context management method according to exemplary embodiments of the present disclosure. In the message context management method, the terminal may generate the message context on the basis of the attached file downloaded from the host device, and may provide the message context to the user.

The terminal may download the attachment from the host device (S1), and may store the downloaded attached file in the DB (S2). In the operation of downloading the attached file, the terminal may download the attached file through wireless and/or a wired network. The terminal may store the attached file in the built-in DB or in the other device outside of the terminal.

The terminal may generate the message context related to the attachment and store the context in the DB (S3). The message context may include the message related to the attached file, the sender/receiver, the terminal, the host device, the communication environment and the like, when the user downloaded the attached file.

The attached file may be displayed (S4) on the display unit by the user. The attached file may be displayed through an application such as a file manager (for example, including a window explorer, “ASTRO” (an ANDROID application) and the like).

When the attached file is selected (S5) by the user, the terminal searches and requests the message context (S6) related to the attached file in the DB. Various methods of selecting the attached file may be provided.

When a large number of contexts are searched, the terminal may display a message context (S7). For example, the terminal may display a list of message contexts. The terminal may display a single message context. When the single message context is displayed, an input window for the user input may be provided to perform a specific function. The setting of the message context to be displayed is similar to the description with reference to FIG. 5.

Various methods of selecting the displayed attached file may be provided. An operation of selecting the attached file and an operation of executing the attached file may be discriminated. For example, in a Windows interface, executing an icon may be performed by a left double click on a mouse, and activating a menu may be performed by a right single click on a mouse.

Accordingly, when using a terminal with a touch screen like a mobile phone, a tablet PC, a personal computer and the like, it is possible to select the attached file by touching the attached file displayed by the icon or the thumbnail using a finger, a touch pen, or the like.

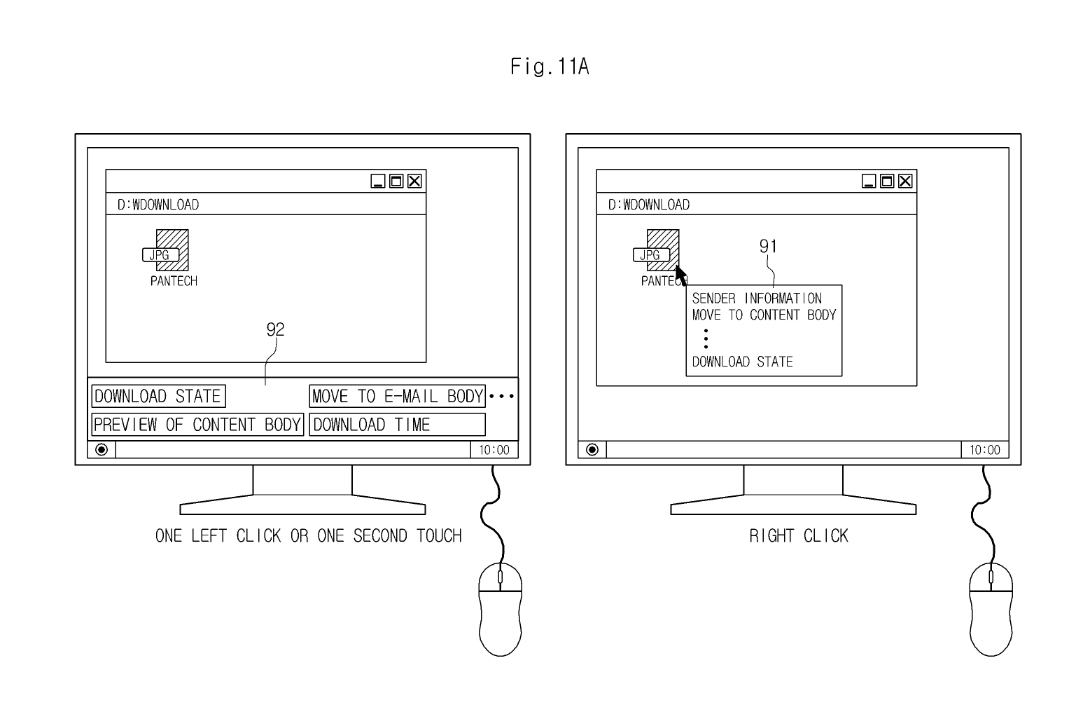

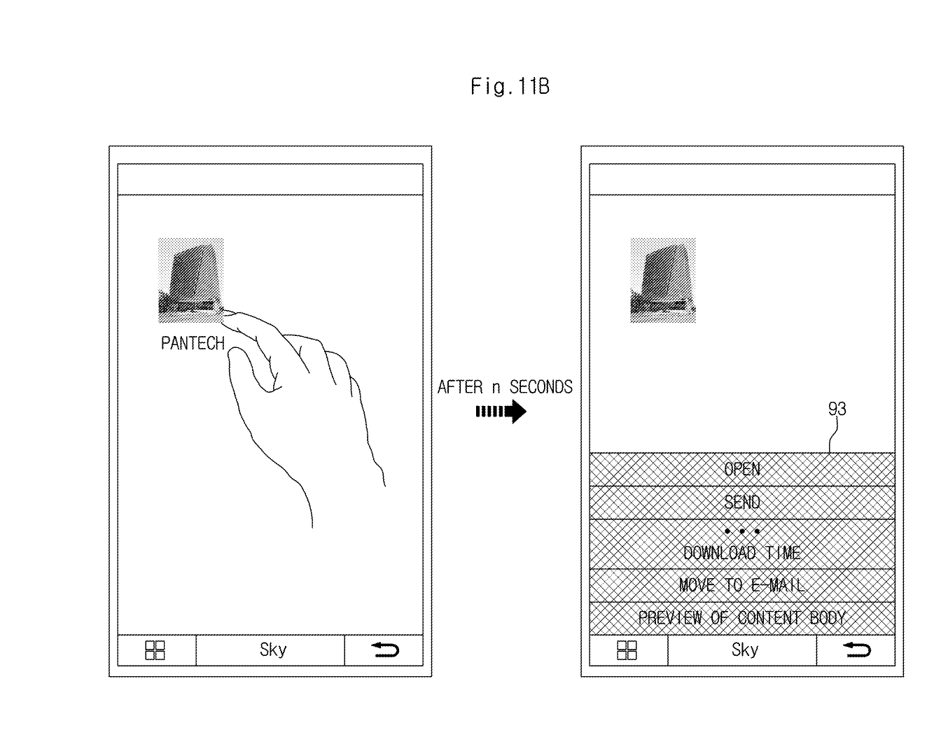

FIG. 11A and FIG. 11B illustrate a message context in a terminal according to exemplary embodiments of the present disclosure. A user can left click on a message context and a message context for the selected file may be displayed in a separate menu 92 positioned in a partial area in the display unit. By selecting the attached file by a right click of the attached file, a message context menu 91 may be displayed (for example, in Microsoft WINDOWS, the right mouse click displays a menu for the attached file). Either of the separate menu 92 or the message context menu 91 may be displayed with a general file information menu for the attached file. The general file information menu can be, for example, when a user right clicks on a file in Microsoft WINDOWS. Either of the separate menu 92 or the message context menu 91 may be displayed in addition to the general file information menu. Either of the separate menu 92 or the message context menu 91 may completely replace the general file information menu.

Referring to FIG. 11B, methods of selecting the attached file and displaying the message context 93 are shown. When the attached file is selected by a touch, the message context 93 may be displayed by a slide type on one side of a touch screen display unit. In some embodiments, when a user touches and holds the icon for an amount of time, i.e., a long touch, the message context 93 may be displayed. The touch includes a touch lasting for an amount of time, e.g., n seconds, as shown in FIG. 11B.

In some embodiments, the terminal may request user authentication before displaying the message context. To protect the personal information of the user, the message receiver may restrict the access to the message context of a third person through encryption of the context.

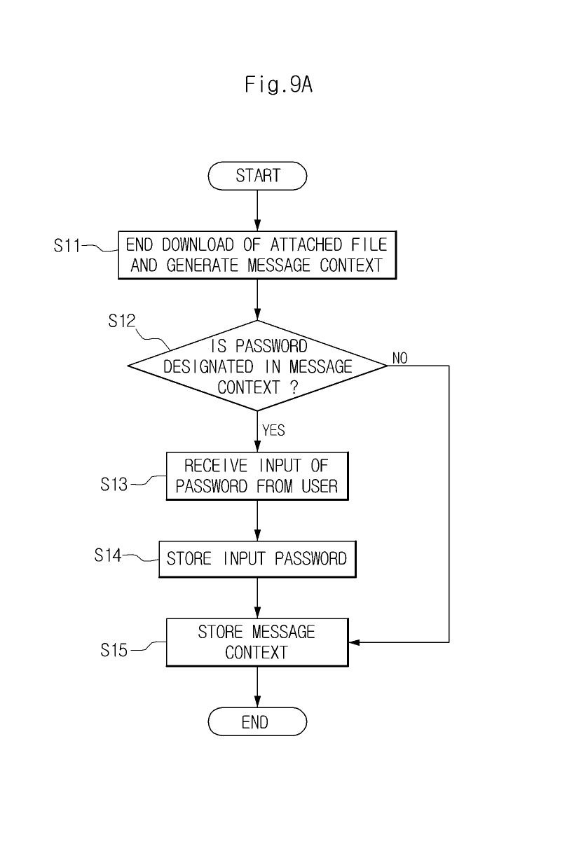

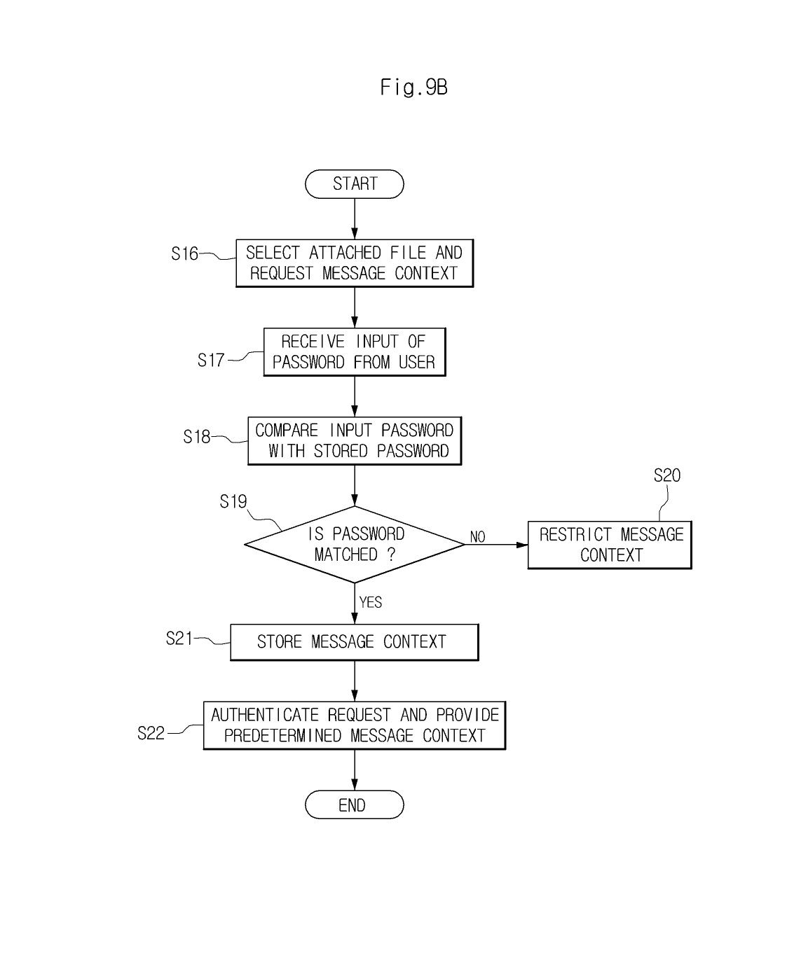

FIG. 9A and FIG. 9B illustrate a method of restricting access to a message context using a password according to exemplary embodiments of the present disclosure. FIG. 9A illustrates a method for generating and storing the message context using the encryption unit 17 according to exemplary embodiments.

In some embodiments, when download of the attached file is completed, a message context can be generated by the terminal, for example, by using the message context management unit (S11). Aspects of the invention need not be limited thereto such that the message context may be generated while the attached file is downloading. In some embodiments, the message context be generated by the sending device and be downloaded before the entire attachment, for example, for a preview. A user may designate whether the message context is to be password protected or encrypted. It may be determined whether or not a password is designated for the message context (S12). If a password is designated for the message context (S12—YES), and the password is input correctly by the user (S13), the encryption unit 17 may store the password in the DB or in the encryption unit (S14). Thereafter, the message context may be stored in the DB (S15). When no password is designated or needed (S12—NO), the message context may be stored in the DB (S 15) without requiring an input of the password.

FIG. 9B illustrates a method for displaying the restricted message context using the encryption unit 17 according to exemplary embodiments. A specific attached file is selected by a user and the terminal or the message context management unit requests the DB for the message context of the selected attached file (S16). The encryption unit 17 may provide a password input window to receive input of password from user (S17) for user authentication through the display unit. The encryption unit 17 compares the input password with the previously stored password (S18) to determine whether or not the request for the message context is authenticated (S19).

When the passwords do not match (S19—NO), the encryption unit 17 may provide an access restriction message through a popup window (S20) and restrict the display of the message context through the display unit. When the passwords match (S19—YES), the encryption unit 17 authenticates the request, the message context management unit stores the message context (S21) and provides a message context to the display unit to display the message context according to the request of the user (S22).

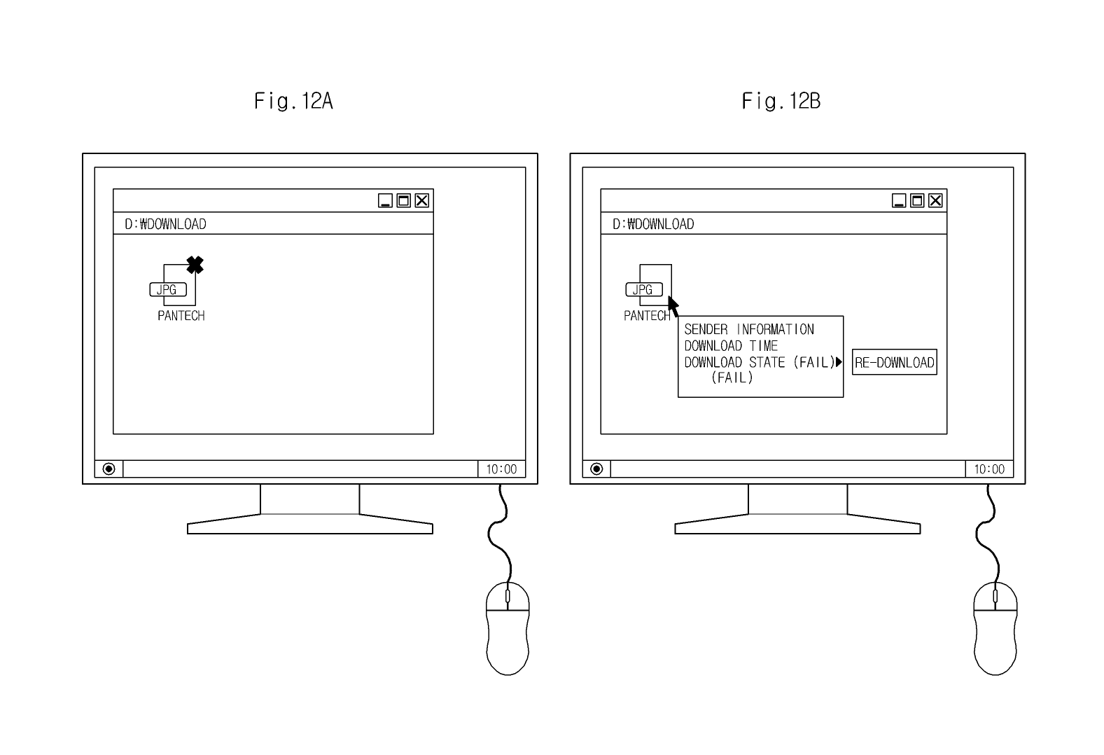

FIG. 12A and FIG. 12B illustrate a re-download of an attachment when the download of the attachment was not completed according to exemplary embodiments of the present disclosure.

As shown in FIG. 12A, the terminal may display that a download of the attached file is not complete, for example, by modifying and displaying an icon for the attachment with an X over a portion of the icon. As shown in FIG. 12B, the terminal may display that the download state as FAIL and convey to the user that a re-download of the attachment is necessary. For example, the re-download may be a resume operation in which downloading is resumed from a point in the downloading or the re-download may be from the beginning of the downloading. Further, the terminal may display that the re-download type available for the attached file.

In some embodiments, user authentication may be necessary to access the message application to re-download the attached file.

For example, B can receive a message, for example, via e-mail, that the attached JPEG, namely, PANTECH.JPG, file was not successfully downloaded.

When B tries to re-download the PANTECH.JPG file, the terminal may execute the application, for example, G-Mail, for the message. The application may receive the input user account and password, and may display a window for the message.

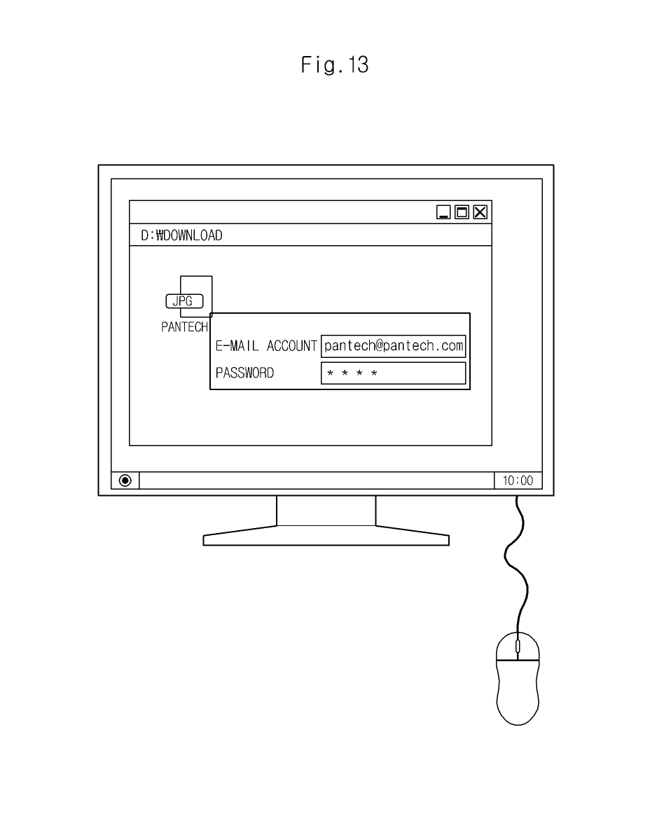

FIG. 13 illustrates a popup window for user authentication according to exemplary embodiments of the present disclosure. In some embodiments, the application for the message may not be separately displayed, and a popup window for inputting the user account and password may be displayed to receive the password and message address. The application may then perform the re-download. Accordingly, the user may perform the re-download with a simplified procedure.

When the user account and password for the application are stored in the terminal, the terminal may immediately perform the re-download according to selection of the re-download.

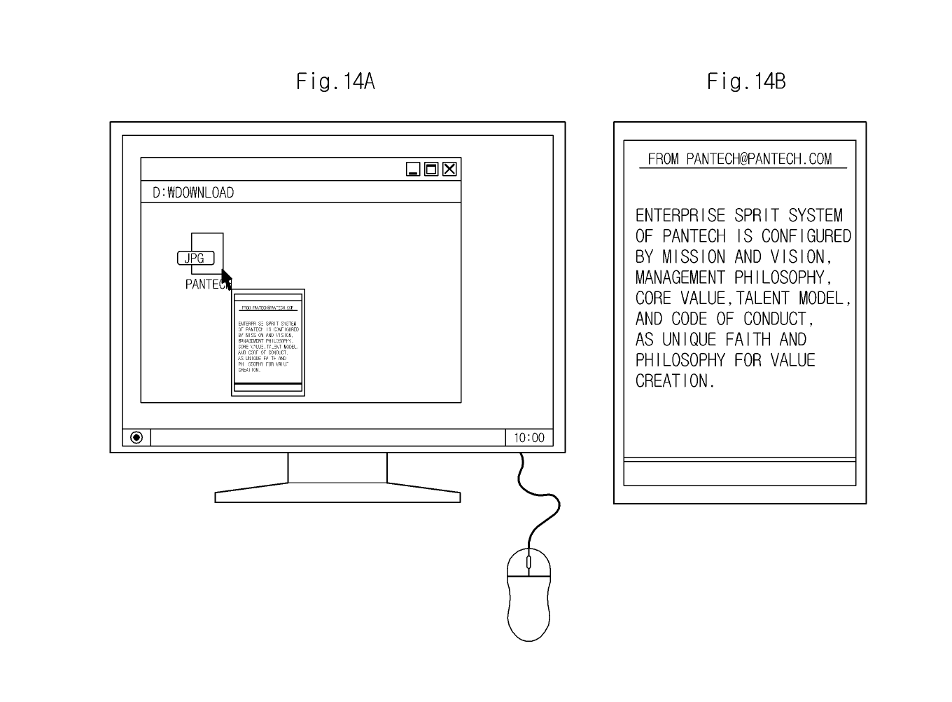

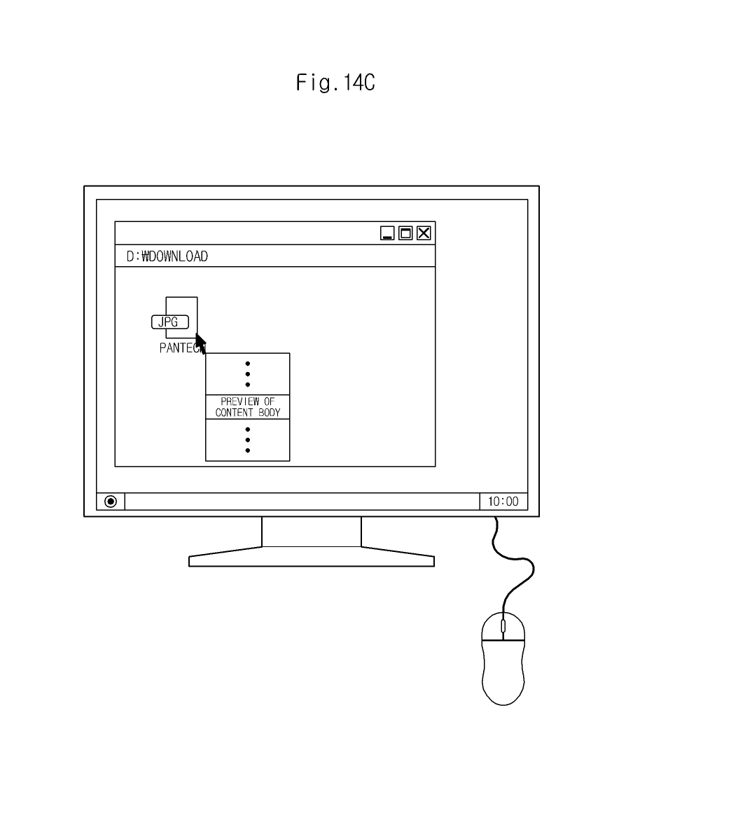

FIG. 14A, FIG. 14B and FIG. 14C illustrate a content body of a message according to exemplary embodiments of the present disclosure.

In FIG. 14A, the content body of the message is temporarily displayed while a pointer or cursor is positioned over the attached file (for example, during selection). When the cursor is not hovering over the icon of the attached file, the content body of the attachment may disappear. When the content body exceeds a predetermined amount of information, only a part of the content body may be displayed.

FIG. 14B illustrates a method of displaying the content body in a terminal providing a small display unit such as a mobile terminal. It is possible to preview the message content body by touching the attached file on the touch screen or the like for a specific time (for example, 1 second or more) or through a different input manner. As shown in FIG. 14B, the content body of the message may be previewed on the entire screen of the display, and such features need not be limited to terminals having a small display unit.

If the content body exceeds a predetermined amount of information, the user may view the lower part of the content body by scrolling the screen of the terminal. Further, the context body of the message may be semi-transparently displayed. FIG. 14C illustrates a preview of the content body that is accessed after the attached file is selected.

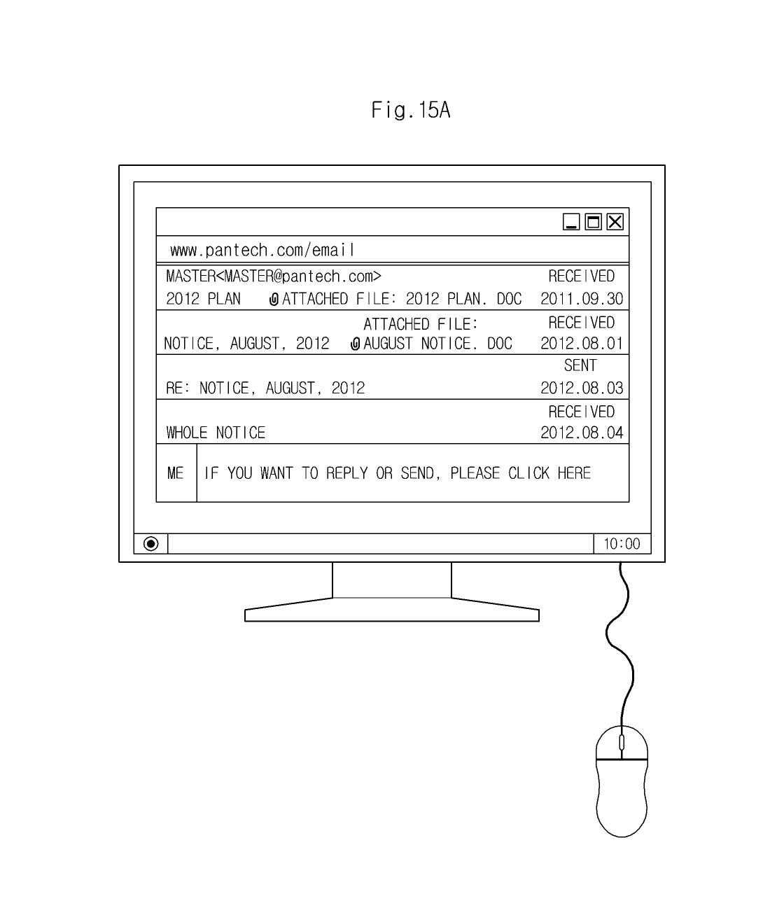

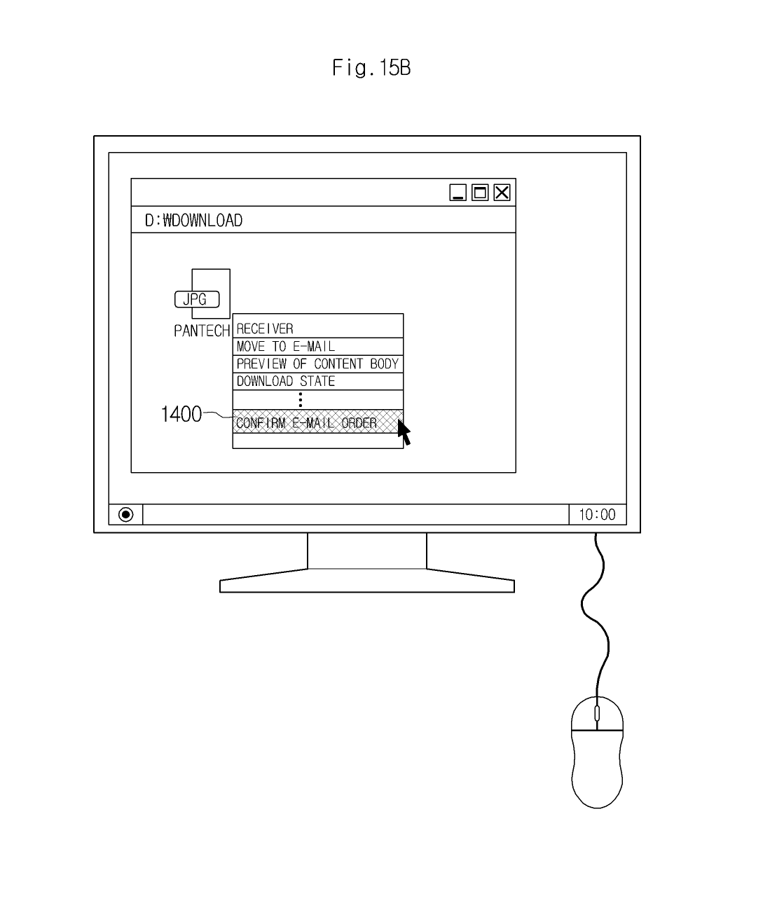

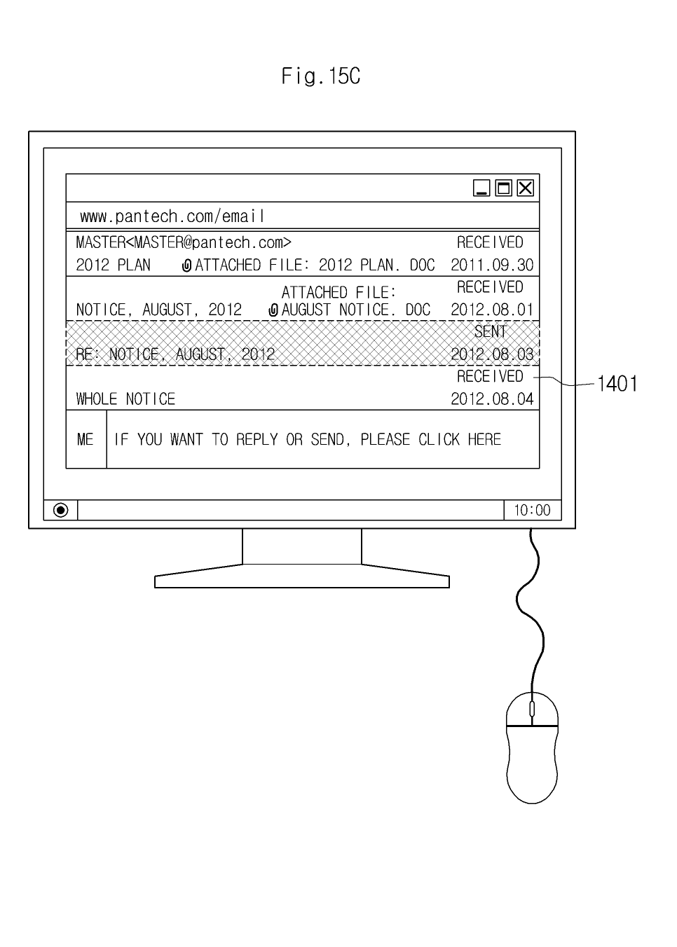

FIG. 15A, FIG. 15B and FIG. 15C illustrate dialogue type messages displaying a position of a message according to exemplary embodiments of the present disclosure. As shown in FIG. 15A, the dialogue type message conveys that messages are sent and received between specific sender and receiver.

When the attachment to the dialogue message is downloaded, the terminal may generate the dialogue type message-entire-information in the message context, for example, as a menu selection or an action button. The dialogue type message-entire-information may not be available until after a complete download of the attachment. In some embodiments, when the dialogue message-entire-information is selected from the list of the message contexts, the terminal may display a plurality of sent and received messages in order to fully convey the message context.

In some embodiments, the terminal may confirm a corresponding order (a position) of the messages including the attached file of the message-entire-information dialogue, and may provide the corresponding order information to the user.

FIG. 15B and FIG. 15C illustrate the corresponding order or position of the messages including the attached file in the entire dialogue type messages. Message order confirmation 1400 may be selected from the message context per FIG. 15B, and may be executed.

As shown in FIG. 15C in a new window or a current window, the entire dialogue type message generated, for example by the dialogue type message-entire-information described above, may be displayed. The entire dialogue type message includes a message 1401 to which the attached file is attached may be displayed. Message 1401 is associated with the “PANTECH.JPG” of FIG. 15B in a received e-mail entitled “WHOLE NOTICE” from “master@pantech.com”, on Aug. 4, 2012 as shown in FIG. 15C.

However, aspects need not be limited thereto. For example, the sending order of the messages from the recently received or sent message may be displayed by numerals. Accordingly, when the files having the same file name are sent and received between a sender and a receiver it is possible to easily confirm the original positions of the files.

Although exemplary embodiments of the present invention were disclosed with respect to managing message contexts in a mobile device, aspects of the invention are not limited thereto.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A message context management method comprising:
receiving, by a messaging application, a message with an attachment;
downloading the attachment;
generating a message context associated with the attachment, wherein the message context comprises information about the message and the attachment; and
storing the message context.

2. The method of claim 1, wherein the downloading comprises storing the downloaded attachment separate from a storage unit used by the messaging application and updating the message context with the location of the attachment.

3. The method of claim 1, further comprising:
selecting the downloaded attachment;
accessing the stored message context; and
displaying the message context associated with the selected attachment.

4. The method of claim 1, wherein the message context indicates that the downloading of the attachment is incomplete.

5. The method of claim 1, further comprising:
modifying an icon to indicate the message context; and
displaying the modified icon.

6. The method of claim 1, further comprising classifying the attachment according to a portion of the information about the message.

7. The method of claim 1, displaying a message context setting window through which properties of the message context are input.

8. The method of claim 1, further comprising providing restricted access to the message context when an access to the message context fails to properly authenticate.

9. The method of claim 1, further comprising displaying the message context in response to at least one of a long touch of the attachment, hovering a pointer over the attachment, and a right click of the attachment.

10. An apparatus including message context management, the apparatus comprising:
a communications interface unit configured to receive with a messaging application a message with an attachment and configured to download the attachment;
a message context manager unit configured to generate a message context associated with the attachment, wherein the message context comprises information about the message and the attachment;
an attached file manager unit to manage the downloaded attachment; and
a database configured to store the message context.

11. The apparatus of claim 10, wherein the attached file manager stores the attachment separate from the database used by the messaging application and updates the message context with the location of the downloaded attachment.

12. The apparatus of claim 10, further comprising:
an input device configured to select the downloaded attachment; and
a display configured to display the message context associated with the selected attachment.

13. The apparatus of claim 10, wherein the message context indicates that the downloading of the attachment is incomplete.

14. The apparatus of claim 10, further comprising a display configured to display a download history of the attachment.

15. The apparatus of claim 10, wherein the message context manager is configured to classify the attachments with a portion of the information about the message.

16. The apparatus of claim 10, further comprising an encryption unit configured to provide restricted access to the message context when an access to the message context fails to properly authenticate.

17. The apparatus of claim 10, wherein the message context comprises a plurality of sent and received messages.

18. The apparatus of claim 17, wherein the message context provides an order to the sent and received messages.

19. A message context management method, the method comprising:
downloading, by a terminal from a host device, messages and attachments to one or more of the messages;
generating a message context related to each of the messages and the respective attachments; and
displaying the message context related to a file selected from the attachments.

20. The method of claim 19, wherein the file selected from the attachments has a file name shared by other attachments, and the message context provides the order in which the selected file and the other attachments sharing the file name were downloaded.
